(19) United States
(12) Patent Application Publication
(10) Pub. No.: US 2023/0289691 A1
(43) Pub. Date: Sep. 14, 2023

(54) SYSTEMS AND METHODS FOR OPTIMIZING BUSINESS WORKFLOWS

(71) Applicant: FlowPatterns, Clovis, CA (US)

(72) Inventor: Christopher SABOURIN, Clovis, CA (US)

(21) Appl. No.: 18/319,195

(22) Filed: May 17, 2023

Related U.S. Application Data
(63) Continuation of application No. PCT/US2021/059917, filed on Nov. 18, 2021.
(60) Provisional application No. 63/115,740, filed on Nov. 19, 2020.

(51) Int. Cl. G06Q 10/0633; G06Q 10/067; G06Q 10/0631

(52) U.S. Cl. CPC G06Q 10/0633; G06Q 10/067; G06Q 10/063116

(57) ABSTRACT

In one aspect, the present disclosure provides a method for optimizing business workflows. The method may comprise generating a work flow map based on one or more model business maps, wherein the one or more model business maps correspond to one or more processes or procedures of a model business; optimizing the work flow map for a target business by adjusting the work flow map based on a business characteristic of the target business, wherein the target business is different than the model business; and generating one or more training programs based on the optimized work flow map.

### CROSS-REFERENCE

This application is a continuation of International Application No. PCT/US2021/059917 filed on Nov. 18, 2021, which claims priority to U.S. Provisional Patent Application Ser. No. 63/115,740 filed on Nov. 19, 2020, which application is incorporated herein by reference in its entirety for all purposes.

### BACKGROUND OF THE INVENTION

Small businesses tend to have high failure rates, with only half surviving five years after launch. Many small businesses fail due to internal conditions such as inefficiency, mismanagement, or failure to diversify business managerial practices.

### SUMMARY OF THE INVENTION

The present application relates generally to creating and optimizing business workflows for businesses across various industries. The systems and methods of the present disclosure may be implemented to generate one or more standardized or customized business workflow solutions for businesses based on model workflows (e.g., business processes, company procedures, management structures, file libraries, etc.) associated with other businesses or companies. The systems and methods disclosed herein may also be used to develop customized learning management systems for training employees, managers, and business owners to work efficiently within their respective roles and in compliance with one or more optimized business workflows.

In one aspect, the present disclosure provides a method for optimizing business workflows. The method may comprise generating a work flow map based on one or more model business maps. The one or more model business maps may correspond to one or more processes or procedures of a model business. The method may comprise optimizing the work flow map for a target business by adjusting the work flow map based on a business characteristic of the target business. The target business may be different than the model business. The method may comprise generating one or more training, guidance, tracking, or monitoring programs based on the optimized work flow map.

In some embodiments, the business characteristic comprises a size of the target business, a client base of the target business, financial data of the target business, or one or more operational procedures of the target business.

In some embodiments, the method may further comprise implementing a feedback loop to adjust the optimized workflow map or the one or more training programs. In some embodiments, the feedback loop is configured to adjust the optimized workflow map or the one or more training programs based on (i) feedback from one or more agents performing a task or procedure or (ii) one or more performance metrics of the target business. In some embodiments, the one or more performance metrics comprise (i) an efficiency of the target business or (ii) an amount of time in which the one or more agents complete the task or procedure. In some embodiments, the efficiency of the target business corresponds to a number of tasks or procedures completed per unit time.

In some embodiments, generating the workflow map comprises (i) generating one or more tasks for completing a process or a procedure of the target business and (ii) assigning a target time limit to complete the one or more tasks. In some embodiments, the one or more tasks are automatically or manually assigned to one or more agents. In some embodiments, the one or more tasks are assigned to the one or more agents using one or more algorithms. In some embodiments, the one or more tasks are manually claimed by one or more agents or by algorithmic suggestion.

In some embodiments, the one or more model business maps comprise (i) a collection of one or more tasks for completing a process or procedure of the target business and (ii) operational data associated with the process or procedure. In some embodiments, the operational data comprises timing information for completing the one or more tasks. In some embodiments, the operational data comprises staffing information for assigning or delegating the one or more tasks to one or more agents. In some embodiments, the operational data comprises an order in which the one or more tasks are completed or performed.

In some embodiments, optimizing the workflow map comprises algorithmically adjusting a timing for performing or completing one or more tasks associated with a procedure or a process of the target business. In some embodiments, optimizing the workflow map comprises adjusting an order in which one or more tasks are performed. In some cases, the one or more tasks are associated with a procedure or a process of the target business. In some embodiments, optimizing the workflow map comprises adjusting staffing for one or more tasks associated with a procedure or a process of the target business. In some embodiments, optimizing the workflow map comprises adjusting a scheduling of tasks associated with a procedure or a process of the target business.

In some embodiments, the method may further comprise using one or more algorithms to adjust the scheduling of tasks associated with the procedure or the process of the target business. In some embodiments, the scheduling of tasks comprises dynamic task scheduling that is implemented via an algorithm, machine learning, artificial intelligence, or heuristics. In some embodiments, the dynamic task scheduling permits real-time modifications or adjustments of customer appointment times to enhance service team and customer timing coordination and efficiency.

In some embodiments, the one or more training programs comprise tools, lessons, guidance, or reference materials on how to complete or perform one or more tasks associated with a procedure or a process of the target business. In some embodiments, the one or more training programs are assignable to one or more agents of the target business. In some cases, the one or more agents comprise an employee, an independent contractor, a worker, a manager, or a business owner of the target business. In some embodiments, the one or more training programs are provided or accessible via wearable hardware. In some embodiments, the wearable hardware comprises a watch, augmented reality (AR) or virtual reality (VR) glasses, AR or VR goggles, or an AR or VR headset.

In some embodiments, the method may further comprise providing dynamic coupled multitask guidance based on the optimized workflow map to enhance service team timing, coordination, and efficiency. In some embodiments, the multitask guidance is provided by or generated using one or more algorithms, machine learning, artificial intelligence, or heuristics.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 schematically illustrates a system for optimizing business workflows, in accordance with some embodiments.

FIG. 2 schematically illustrates a computer system that is programmed or otherwise configured to implement methods provided herein.

FIG. 3 schematically illustrates an exemplary method for optimizing workflows, in accordance with some embodiments.

FIG. 4 schematically illustrates a system configured to generate outputs that can be used by a target business to optimize or improve its workflow, in accordance with some embodiments.

FIG. 5 schematically illustrates a learning management platform, in accordance with some embodiments.

FIG. 6 schematically illustrates an exemplary data architecture for implementing the systems and methods of the present disclosure.

FIGS. 7-11 schematically illustrate a user interface configured to provide a user with a graphical overview of a process to be completed for a particular patient or operation, in accordance with some embodiments.

FIG. 12 schematically illustrates an example of a process view for a root canal treatment, in accordance with some embodiments.

FIG. 13 schematically illustrates a survey that may be completed by one or more users involved in or supporting a process or any tasks associated with the process, in accordance with some embodiments.

FIG. 14 schematically illustrates a dashboard for viewing and managing workflow procedures, in accordance with some embodiments.

FIG. 15 schematically illustrates a schedule view for viewing a scheduling of tasks for one or more operations or processes, in accordance with some embodiments.

FIGS. 16-17 schematically illustrate an overview of operatories that are in progress, in accordance with some embodiments.

FIG. 18 schematically illustrates an exemplary list of process instances displayed within a user interface, in accordance with some embodiments.

FIG. 19 schematically illustrates a user interface configured to display process details for a process instance, in accordance with some embodiments.

FIGS. 20-21 schematically illustrate an exemplary list of processes organized within a user interface, in accordance with some embodiments.

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

In an aspect, the present disclosure provides systems and methods for creating business workflows. As used herein, a business workflow may refer to a set of standard processes, procedures, operations associated with a business. In some cases, a business workflow may comprise information or data associated with a flow of duties, tasks, or various work product, or an interaction of various departments or divisions within a business. In some embodiments, the business workflows may be generated, modified, or optimized based on business workflows of model companies that are successful. In some cases, the business workflows may be customized or optimized for other businesses in a same industry. In other cases, the business workflows may be customized or optimized for other businesses in different industries.

In another aspect, the present disclosure provides systems and methods for creating learning management systems or platforms to train employees and/or business owners to work in accordance with one or more standardized, customized, or optimized business workflows.

In one example, the present disclosure provides a method for optimizing business work flows. The method may comprise obtaining business maps (i.e., map of standard processes and procedures) from a model business. Model businesses that provide business maps may receive rewards or incentives for sharing their data/processes. In some cases, the model business may receive commissions if its data is used for flow pattern or business work flow modeling for other companies.

In some embodiments, the method may comprise generating standardized work flow information based on the business maps. In some embodiments, the method may comprise generating customized/optimized work flow information that is tailored for a specific business and/or a specific industry.

In some embodiments, the method may further comprise creating training programs to teach employees how to operate within the optimized work flow, or in accordance with one or more standardized processes or procedures. In some cases, the method may further comprise implementing a feedback loop with data analytics to further optimize the work flow processes and/or the training programs. For instance, training programs can be adjusted based on industry specific or business specific needs. The training programs may provide comprehensive on-line training and certification per position and/or function.

In some embodiments, the training programs may be used to train employees to comply with certain standardized work flows that may be similar to the work flows of other businesses in a same or similar industry. In such cases, employees who have been trained for a certain standardized work flow can transition to other companies/industries with a similar work flow, thereby minimizing training needs and increasing the value of training. In some cases, the systems and methods of the present disclosure may be implemented to create and/or manage a job matching board to coordinate internal or external hiring of employees who have completed certain training programs.

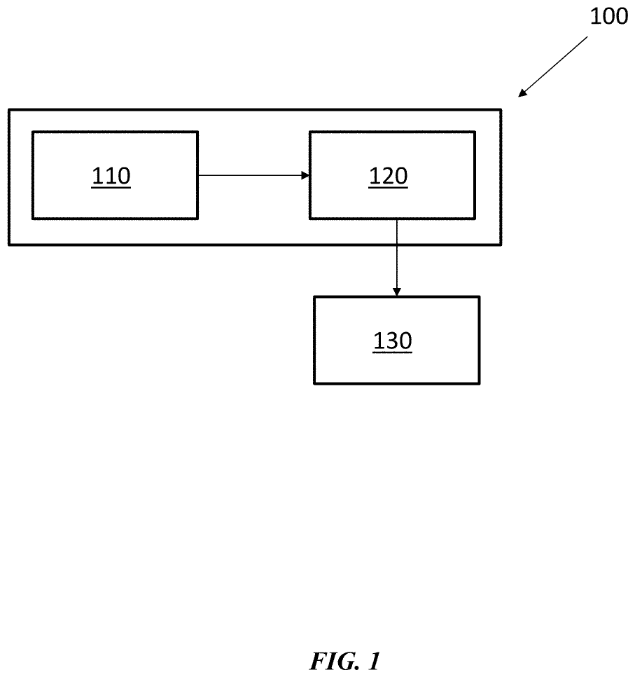

In another example, the present disclosure provides a system for optimizing business workflows. As illustrated in FIG. 1, the system 100 may comprise a workflow generation module 110. The workflow generation module 110 may be configured to generate one or more business workflows based on one or more business maps associated with a model business or company. The one or more business maps may be obtained from the model business or company, or generated based on an evaluation of the business, the employees of the business, and/or various operational aspects of the business. The workflow generation module 110 may be configured to generate customized and/or optimized work flow information that is tailored for a specific business or industry.

The system 100 may further comprise a learning management module 120. The learning management module 120 may be configured to generate one or more training programs to teach employees how to operate within a standardized, customized, or optimized work flow that is generated by the workflow generation module 110. In some cases, the learning management module 120 may be operably coupled to an external device 130. The external device 130 may comprise an electronic device for viewing the one or more training programs. In some cases, the external device 130 may comprise virtual reality headsets or a display device (e.g., a television or a monitor) that is located within an office or a workplace of the business or an employee of the business. The external device 130 may be used to broadcast training programs or digital content (e.g., training videos or storyboards) to employees.

As described elsewhere herein, the one or more training programs may comprise, for example, instructions, guidance (e.g., live guidance), tools, lessons, or reference materials on how to complete or perform one or more tasks associated with a procedure or a process of the target business within a target time or goal time. In some cases, the one or more training programs may be assignable to one or more agents of the target business. The one or more agents may comprise, for example, an employee, an independent contractor, a worker, a manager, or a business owner of the target business.

In some cases, the one or more training programs may be provided or accessible via wearable hardware. The wearable hardware may comprise, for example, a watch, augmented reality (AR) or virtual reality (VR) glasses, AR or VR goggles, or an AR or VR headset.

The systems and methods of the present disclosure may provide a variety of benefits to businesses, including small business, medium-sized businesses, and large businesses. Such benefits include, for example, structured workflows, a clear division of responsibilities among team members, increased worker productivity. In some cases, the systems and methods of the present disclosure may be used to generate digital road maps that can help business owners optimize business operations and identify areas for improvement/growth. When implemented, the systems and methods of the present disclosure may also open up time for business owners/managers to focus on clients instead of training employees. Further, the learning/training programs disclosed herein may allow businesses to grow and scale while reducing reliance on institutional memory or individual staff. As an added benefit, the learning/training programs disclosed herein may be customized based on values specific to each company, thereby reinforcing the culture and values of each company.

In another aspect, the systems and methods of the present disclosure may be used to provide businesses with a blueprint for growth by empowering subscribing businesses with a finely honed system of flows, processes, and trainings. The benefits of the systems and methods of the present disclosure go far beyond increasing income. For example, the systems and methods of the present disclosure can be implemented to foster systematic business expansion, ease team member training, optimize the patient/customer experience, and manage human resources. The systems and methods of the present disclosure give businesses a workflow process that they can confidently follow every day to support patients/customers efficiently while giving each team member clear roles, guidance, and responsibilities.

The systems and methods of the present disclosure can be used to create a common system for increasing revenue and production. For example, the systems and methods of the present disclosure can be used to optimize the efficiency and capacity of a medical practice while decreasing doctor exertion, allowing him or her to see more patients. The systems and methods used to achieve this may be transferrable to other industries, fostering success in four key areas:

Training

The systems and methods of the present disclosure make training simpler and more efficient for subscribing companies, alleviating the stresses of onboarding, sharply defining team member responsibilities, and increasing team member retention. For example, it can typically take 1-2 years to fully train front-of-office team members of a medical practice and 3-9 months to train back-of-office team members. For many independent small businesses, such training may typically comprise side-by-side shadow training, which can be resource and time intensive. Newer team members can also forget how to perform certain tasks throughout the day and may need assistance with their responsibilities. The systems and methods of the present disclosure provide team members with centralized, systematized learning resources that they can refer to whenever they wish, promoting independence, confidence, and a sense of shared ownership.

Recruiting

The systems and methods of the present disclosure can be used to generate and manage internal job postings, which can help businesses recruit for hard-to-hire and hard-to-retain positions with less effort. It can sometimes be difficult to hire back-of-office staff for a medical practice, for example. The perfect staff member might be fresh out of school or working at another office. The systems and methods of the present disclosure can be used to screen for, select, and train the right people in order to create the perfect team for a business.

Improving Workflow

The systems and methods of the present disclosure can be implemented to divide each procedure into multiple parts or steps and identify which parts or steps can be handled by whom, thereby allowing a business to serve more patients and maximizing the time of team members. Improving workflows also provides employees and business owners with new opportunities for specialization.

Customer Satisfaction

In today's lightspeed world, customers expect service to be fast and highly efficient. Making an effort to meet that expectation pays off since highly efficient businesses can serve more customers and earn more revenue. At a general medical practice, for example, patients want fast and efficient care, spending as little time with the doctor as possible. They are busy, may have left work for their appointment, and don't want a lot of “dead” waiting time. By managing the flow of patients efficiently, not only do practices see more patients, but each patient also benefits—by moving through the care experience quickly and seamlessly. It is possible to finely choreograph these experiences, so each patient is seen by the right staff member at the right time, eliminating long waiting periods. The systems and methods of the present disclosure may be used to develop and implement these efficiency-building mechanisms, which can be monitored or controlled through a user-friendly interface.

In another aspect, the systems and methods of the present disclosure may help businesses understand how each industry runs, thereby reducing barriers to move into a new sector. In some cases, the systems and methods of the present disclosure can also provide key data descriptors on existing businesses for sale, offering more secure purchases for both a buyer and a bank.

Services Provided

The systems and methods of the present disclosure may be implemented to provide businesses with a variety of services, benefits, and features, such as:
SaaS software programs for office learning and management
Online digital platform software with learning content on flows, systems, processes, trainings, hiring scripts, KPIs, etc.
Team member training and development tools
Work performance improvement tools
Business systems and processes flow mapping
Tracking and reporting tools
Practice/business management tools
Training certifications and recertifications
SaaS LMS training programs
Small business sales data management
Metadata collection, analysis, and sales
Per diem temporary team members hiring and management
Business systems implementation with consulting, workshops, and onboarding
Business improvements via access to programmers, robotic automation companies, etc.
Advertising opportunities for products and services specific to the industry
Mobile applications for tracking and managing business processes and/or training programs
Personality-assessment-style team member screening services
Peer-to-peer and owner/team member communication forums
Workforce robotics
AI optimizations
Job posting and job matching sites customized for a specific industry or business sector
Direct team member job training completion certificates
Meta-data analysis to give public guidance on career path supply and demand; and
Meta-data for macroeconomic small-business index (vs. large-business index, i.e., the stock market, which is made to be volatile)
Deep data analytics for business location recommendations
Real-time digital coaching and question/answer sessions
Two-way digital communications (e.g., via a virtual event or session) to facilitate training and to broadcast information or updates pertaining to the business or a particular workflow
Development of standardized business-to-business cross-system inflow and outflow

Workflows

The present disclosure provides systems and methods for generating and implementing a forest-view, comprehensive software-based work flow solution for one or more companies or business entities. The present disclosure provides systems and methods for creating standards for how a particular business type functions, while maintaining individual ownership and freedom to adjust as needed. Such standards can be implemented by curating and digitizing a comprehensive, all-in-one, plug-and-play, in-use, bottom-up, real-world, best-in-class, digital training program specific to that standard service industry (and within a defined geography, in some instances). In some cases, the digital training programs may be tied to an ideation forum so that the package gets refined each year. An in-office dedicated system may also be provided for community, information, and industry announcements as needed. The in-office dedicated system may comprise, in some non-limiting embodiments, a display unit or wearable hardware (e.g., watches, AR/VR headsets, etc.). In some alternative embodiments, information or announcements may be provided via one or more systems that are remote from the physical office space of the business.

The systems and method of the present disclosure may be implemented by taking an existing best-in-class small business, then fully business mapping all aspects of the business (e.g., how all the workflow duties are performed and how the departments interact with each other), then refining and converting business maps into digital training programs tailored for each person or position. Software reinforcing the “when” may also be developed. Such training programs may be created based on how a whole office runs, including stages of growth/hiring timing, thereby minimizing the need to hire multiple consultants over a decade or more.

After obtaining or generating initial business maps, the initial business maps may be converted into user-friendly training. In some cases, one or more training packages may be curated for a company or an industry. In some cases, the training programs may be non-industry specific, with a focus on optimizing for efficiency and/or time. The training programs may also be adjusted based on industry specific needs. This may reinforce the functions of workflows taught in the training programs.

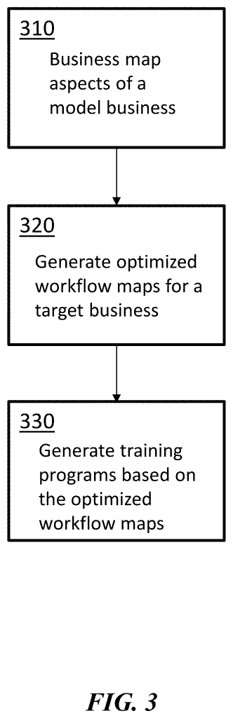

FIG. 3 illustrates an exemplary method for optimizing workflows. In one step 310, the method may comprise business mapping all aspects of a model business. In another step 320, the method may comprise generating one or more customized or optimized workflow maps for a target business, based at least in part on the business map associated with the model business. In another step 330, the method may comprise converting the one or more customized or optimized workflow maps into one or more training programs for employees and/or business owners of the target business.

In some embodiments, standardized workflow information can also be used to enhance automations, whether via software OR hardware (e.g., robots), without needlessly vanquishing human jobs and (importantly) known usefulness.

In some cases, the systems and methods of the present disclosure may be implemented in conjunction with functional role training and certification for unemployed persons, to improve their hiring potential. The present disclosure further provides a coupling aspect for such a platform that combines industry-specific blue collar employee-employees job connections with business-specific ratings for the small business sector. In some cases, the platforms may provide availability indicators for various industry sectors, showing where job role needs are, and to also help new blue-collar employees select a career. This will also help blue collar employees because as more offices adopt workflow standardizations in an industry, trained employees can become more easily mobile, and their workflow knowledge/value can be applied to different small businesses when they leave and look for a new job.

In some embodiments, the systems and methods of the present disclosure may be used to standardize small service businesses' workflows to facilitate a transition from information asymmetry to information parity via curated social proof. The systems and methods of the present disclosure can help business owners to avoid having to re-invent the wheel on how to run their type of business, and save time and money while improving employee retention/mobility, and mitigating negative impacts due to lost team members. In particular, the systems and methods of the present disclosure allow a business to implement a standardized way of running the business efficiently, and improve operations further so that the business runs more efficiently over time, without relying on random business owner process ideas that may not provide any material benefits to the operational efficiency of the business.

The systems and methods of the present disclosure allow businesses to avoid business failures due to internal conditions (i.e., conditions relating to how a business is run or managed) by adopting the best practices of the highest performers in their field. The systems and methods of the present disclosure not only provide the crucial knowledge transfer of process documentation to subsequent company staff and managers, but also provides updated guidance about how the firm is meeting its goals relative to its peers in the same industry.

In some cases, the systems and methods of the present disclosure may be implemented or augmented using aggregated data collection techniques and targeted advertising opportunities.

Data Providers

The dataset underlying the platform is in part populated with data from high-performing businesses. High performers may be identified through one or more digital searches using criteria (e.g., performance criteria, efficiency statistics, and/or KPIs) followed by a selection process. In some cases, the selection process may be performed by one or more human operators. Alternatively, the selection process may be implemented by way of one or more algorithms or one or more trained machine learning models. The rationale for a high-performing business to share their processes with their industry peers (that is, act as “data providers”) is multi-faceted. The potential incentives for doing so are outlined in brief below:

1. Free Operating Resources (Business Process Mapping & Learning Management System Development)

Participating data provider firms will receive multiple operational supports as part of their participation, including business processing mapping and learning management system development. The systems and methods of the present disclosure may provide a Learning Management System or Learning Experience Platform that is populated with employee training materials that align with the high-performer processes. As part of this process, data provider firms will receive employee training content customized to their optimized processes, empowering them to ensure training consistency and reduce employee turnover. Providing firms with a comprehensive Learning Management System or Learning Experience Platform would give employees the right resources and significantly boost training efforts.

2. Professional Acknowledgement

A public competition that names specific companies as the high-performers in their field could be valuable to company owners in multiple ways. Stronger reputations can have positive effects on a firm's customer loyalty, supplier credit and terms, employee retention, and access to investor capital and these can be strong motivators for managers to treat their reputation as a strategic asset.

3. Financial Compensation

The systems and methods of the present disclosure give data provider firms a percentage commission on each blueprint model or instance sold using their process or workflow data. In some cases, the sale of static maps also has a commission. Financial commissions can be calculated based on a lifetime spanning at least about 1 year, 2 years, 3 years, 4 years, 5 years, or more.

4. Crowd Participation

In some cases, business may be willing to share knowledge (e.g., knowledge regarding hazardous incidents in the on-shore oil and chemical industries) if they are protected from their peers gaining a competitive advantage from learning about their mistakes. Businesses may be incentivized to collectively participate for mutual sharing of information if the risks of such sharing are minimal.

5. Blueprint Business Safe Zone

Companies with minimal interest in growth can be incentivized to share business workflow blueprints corresponding to those areas or aspects of the business that the company does not immediately intend to grow. This can give such companies an additional revenue stream in exchange for their workflow data. To further protect the interests and customer base of such companies, a “safe zone” can be implemented such that certain businesses (e.g., those with a similar business purpose or customer base) within close proximity to the company cannot purchase a blueprint or workflow map based on the workflows of the blueprint company. For example, businesses within a predetermined range of a model business or in a particular geographic location may be denied access to workflow maps developed based on the workflows of the model business. In some cases, such safe zones may be in place for a predetermined time period (e.g., at least one day, one week, one month, one year, or more).

Participants

Small business growth can be defined according to five key stages with separate characteristics: existence (Stage 1), survival (Stage 2), success-disengagement (Stage 3-D), success-growth (Stage 3-G), take-off (Stage 4), and resource maturity (Stage 5). The successful businesses most likely to participate as high-performers and agree to donate their processes as templates fall into the Success-Disengagement stage (Stage 3-D) and the Resource Maturity stage (Stage 5).

For Stage 3-D companies, developing another monetization stream for assets (e.g., business operation strategies or procedures) the owner has little interest in improving could be an attractive option. In addition, the positive reputational effects of sharing such business operation strategies and procedures can serve as a useful springboard for other ventures or future projects. For 3-D companies with no interest in growth, creating a “safe zone” where businesses within close proximity to the company cannot purchase or use the company's business operation strategies and procedures can further incentivize sharing of such data.

For Stage 5 companies, free process mapping can be a strong incentive to participate as a high-performer, because they get the benefit of someone reviewing their processes after a major growth event and institutionalizing new practices that “lock in” the organization's newfound strengths with a new set of procedures that align with the company's goals and address the risks of “ossification” (i.e., a lack of innovative decision making and the avoidance of risks). For these companies, the development of training programs is also especially valuable, because growth tends to require new staff. Consistent, comprehensive training modules are crucial for ensuring new personnel are smoothly integrated.

Inputs

In some cases, a blueprint office may be identified based on an application comprising one or more assessments of or questions about the business, its management, or its employees. In some cases, the application may comprise a pre-employment test (e.g., a predictive index test or a criteria-based personality assessment) or a cognitive test. The blueprint office may then be selected based on a review of current training techniques, current business processes, business financials, and/or business credit. Further, business owners and/or employees may be interviewed about their roles and functions within the business. Once a blueprint office is selected, various business processes may be identified or selected for mapping.

Outputs

The systems and methods of the present disclosure may be implemented to generate one or more outputs based on the inputs described above:

Architecture Map—provides a summary flow chart that establishes the backbone of the process, along with the main suppliers, inputs, customers, and outputs.

Process Map—defines the current state process—the who, what, when, where and why of the process—and points to how tasks are executed. The process map also captures unresolved problems and opportunities associated with the process.

Process Connectivity—assesses and troubleshoots department disconnects through a System Alignment Workshop.

Information Matrix—identifies knowledge required to support task execution and describes the task's type of transaction and software/hardware utilized.

Hierarchy maps—lay out the division/grouping/ordering of group tasks.

Problem Matrix—evaluates, classifies and prioritizes improvement opportunities. Additionally, identifies Quick Wins, which can be resolved within 90 days by process teams.

Process Improvement Plan—establishes the main goals, actions, responsibilities, and dates to implement the desired quick win improvements.

File or content libraries—organize and compile checklists, job aids, scripts, and other resource materials for employees or business owners.

Storyboards—display one or more illustrations or images displayed in sequence for the purpose of visualizing a motion picture, animation, motion graphic or interactive media sequence corresponding to a task to be performed.

Videos—display one or more recordings of workflows being performed to guide employees through a task.

Learning Modules—train employees to work compatibly and efficiently within a new workflow structure.

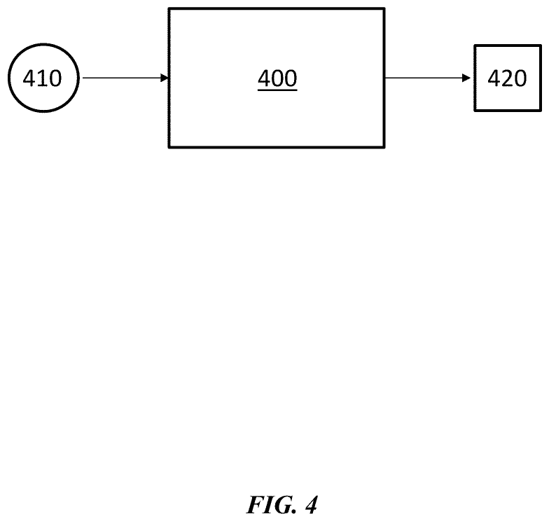

FIG. 4 illustrates an exemplary system 400 configured to generate one or more outputs that can be used by a target business to optimize or improve its workflow. In some embodiments, the system may be configured to use a set of inputs 410 to generate a set of outputs 420. The set of inputs 410 may correspond to the inputs described above, such as answers or responses to assessments of or questions about a model business, its management, or its employees. In some cases, the set of inputs 410 may correspond to answers or responses to a personality test, a cognitive test, or a set of interview questions. In some cases, the set of inputs 410 may correspond to information or data pertaining to a model business's current training techniques, current business processes, business financials, and/or business credit. The set of outputs 420 may correspond to the outputs described above, such as architecture maps, process maps, process connectivity assessments, information matrices, hierarchy maps, problem matrices, process improvement plans, file or content libraries, storyboard, videos, and/or learning modules. The set of outputs 420 may be utilized by a target business (or employees and business owners of the target business) to optimize the workflows and efficiency of the target business.

Learning Management System

The systems and methods of the present disclosure may be used to create a learning management system that trains employees to work efficiently within a workflow structure. The learning management system may provide several features:

End User Training

The systems and methods of the present disclosure may provide customized training guides and how-to videos for new team members. Clear divisions will be made for the various roles team members play within the office, outlining all their duties and functions. These will take the train-the-trainer approach.

Conceptual Training

The systems and methods of the present disclosure may provide team members with additional training that aligns with the mission, values, and goals of the company. A wide variety of educational resources and personal development tools will be made available. Standard operating procedures will be established in writing.

The end user training and conceptual training may be provided through a digital system comprising, for example, augmented reality or virtual reality wearables and/or related software interfaces. The augmented reality or virtual reality wearables may be configured to provide users (e.g., employees or workers of a target business) with a virtual interface for accessing and viewing training content that can help the users to perform tasks or processes more efficiently.

LMS Features

The learning management system disclosed herein may provide the following features and services to employees and/or business owners:
Course content with lessons and quizzes
Document uploads
Video and audio uploads
Learning pathway design
Notifications by chat and email about courses
Course and module feedback
Course completion
Progress reporting
Tracking analytics
Reporting & compliance mapping (data retention, Xcel, PDF tracking reports)
Practice statistics
The ability to edit & improve content
Assign subjects to individuals
Use as a branding & marketing tool
Course management
Testing tools
Integration
Tech support
User feedback, including a blog forum
Anonymous stats and graph board with daily virtual awards
Suggestions; and
Inventory virtual marketplace
Business/practice sales
Gamification

When the course content within the learning management system is established, the systems and methods of the present disclosure can be used to add a layer of gamification to make the learning more enjoyable for users. For example, the learning management system may implement a leaderboard, a ranking system, or a series of unlockable badges corresponding to a user's progression through various training modules.

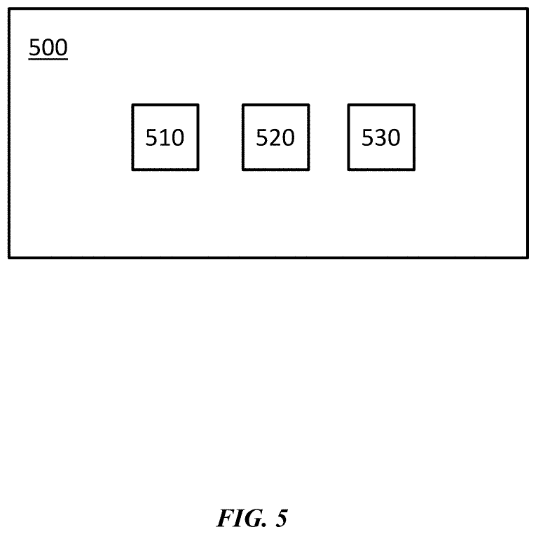

FIG. 5 illustrates an exemplary learning management platform 500 that may be implemented using the systems and methods of the present disclosure. The learning management platform 500 may comprise one or more components or features accessible to employees and/or business owners. For example, the learning management platform 500 may comprise a set of features 510 corresponding to business workflow maps that are customized or optimized for a target business. In some embodiments, the learning management platform 500 may comprise another set of features 520 corresponding to training programs (e.g., end user training and/or conceptual training as described elsewhere herein). In some embodiments, the learning management platform 500 may comprise another set of features 530 corresponding to video and/or audio data that can be broadcasted or transmitted to one or more employees of a business. The video and/or audio data may comprise information or instructions to train or guide employees on how to perform a certain task or operate within a certain role or function in the business. In some cases, the video and/or audio data may be provided to employees via a virtual reality (VR) or augmented reality (AR) headset, or via wearable technology or hardware or other display units capable of displaying or broadcasting information. In some cases, the wearable technology or hardware or other display units may be located at a workplace or an office of one or more employees. The wearable technology or hardware may comprise, for example, watches, AR/VR glasses, AR/VR goggles, AR/VR headsets, etc. Wearables (e.g., watches, AR/VR glasses, AR/VR goggles, and/or AR/VR headsets) may be ideal for service business employees, and can provide an immersive, hands-free training, guidance, or learning experience.

Platform

The systems and methods of the present disclosure may provide businesses with unprecedented access to best-in-class process workflows coupled with training materials that have been adopted by the highest performers in their respective industries. The systems and methods of the present disclosure may provide businesses with a SaaS (Software-as-a-Service) platform that combines process and performance mapping, learning management, and administration features to improve business operations. As more user data is collected by the platform, the model templates continuously adapt with vetted crowdsourced improvement suggestions in each specific industry segment. The systems and methods of the present disclosure may be used to break down the traditional silos that prevent the average small business owner from getting ahead, and can provide businesses with clearly detailed practices, educational material, and the resources to enhance operational efficiency and promote business growth. As adoption increases, new monetization opportunities may be implemented, such as collated data sales, improvements collaborations, augmented reality (AR) or virtual reality (VR) implementation training, AI workflow assistance, and/or industry-siloed advertising.

Product Features

The platform may comprise multiple components or modules that come together to measure company and personnel performance against optimal company processes and requisite training requirements for high-performers in each industry segment.

Learning Management System (LMS)

The LMS module comes pre-populated with training material to teach personnel best practices (and avoid the common mistakes) for handling business and administrative functions. All the training is based on staff routine at high-performing industry peers. The LMS tracks every employee's individual progress in learning each best practice and recommends areas where they need to develop to become high performing.

Practice Management

Some practices may report on Key Performance Indicators (KPIs) to compare against their industry's high performers. This requires that the system captures practice management data (i.e., scheduling, accounting, etc.). This information may be manually recorded or automatically entered via an Application Programming Interface (API) with an existing practice management or scheduling systems.

Marketing/Advertising

A key indicator of a business' current and future performance is customer volume. This module houses mapping and data related to marketing efforts and sales conversations, giving users' key insights into which marketing channels are performing well compared to industry benchmarks and which are not.

Performance Reporting

No business intelligence platform is complete without strong reporting tools. This module gives users the ability to visualize their progress in real-time, analyze their historical growth, and predict future performance trends. High-performer benchmarks, as well as user community averages, give every user context for their KPI scores. There is also a running statistics board with anonymized firm identities/avatars to illustrate firm rankings and efficiency scores. In some cases, the efficiency scores may correspond to Process Cycle Efficiency (PCE), a lean production metric which may be represented as a ratio of value-added time to total time required to deliver goods or services to customers. In some cases, the efficiency scores may correspond to the number of jobs processed quickly (i.e., under a certain amount of time) versus the total number of jobs processed for a given time period. In some cases, the efficiency scores may measure an amount of time spent in a fast process divided by the total time spent in the entire process.

Data Analytics

Underlying all these modules is a comprehensive data analytics toolset. Anonymized processes and performance data from top-performing users lets other users benchmark their performance data and adjust their processes to gradually align to best practices in every area, from staff development to marketing to practice management. With continuous use of the platform, every user can measure best practice “absorption”—that is, the degree to which they have standardized on the same processes used by the high-performing firms and the impact it has had on their firm's performance. This dataset could be monetized in other offerings.

Training

Staff training for business operations is captured in the LMS module, but staff also need training resources to effectively use the platform. There will be a more basic dashboard for staff to use. In addition, the training will include a multi-perspective “Day at the Office” video clips demonstrating the high-performing office and its processes in action.

The training for every role in each instance will be available to individuals at no cost, subject to the relevant federal and applicable state rules and regulations regarding licensure for the position. Individuals who successfully complete the trainings will receive a certificate of competition. Users can view the candidates who have successfully completed training and are looking for work in order to make hiring decisions. This vetted talent pool will accelerate adoption because 1) new adoptees will have a talent pool they can immediately leverage and 2) candidates will use their certificates of competition to market themselves, thereby introducing the platform to new audiences.

Data Architecture

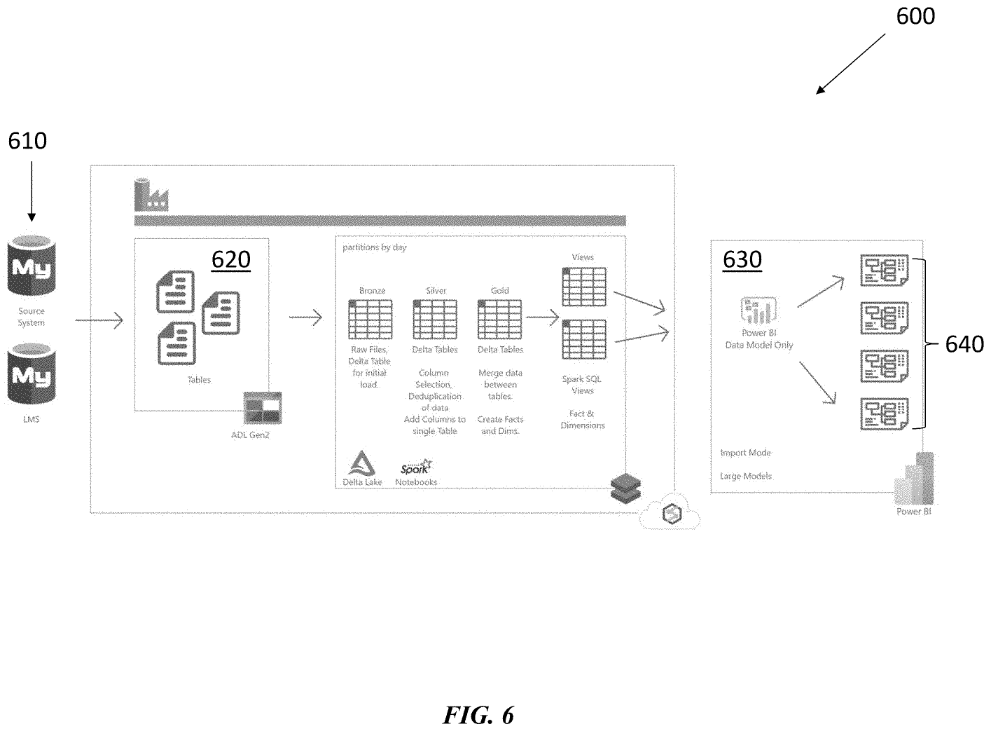

FIG. 6 schematically illustrates an exemplary data architecture 600 that may be used to implement the systems and methods of the present disclosure. The data architecture 600 may comprise one or more models, policies, rules and/or standards governing the collection, storage, arrangement, integration, processing, and/or use of data to generate (i) optimized business models and work flow maps and (ii) training programs based on the optimized work flow maps. In some cases, source data 610 comprising information on a model business work flow map may be imported, organized or merged into one or more tables 620, and provided to a data model 630 that is configured to generate one or more optimal work flow maps 640 for a target business based on the source data or any inferences derivable from said source data. In some cases, the source data 610 may comprise information on the type of tasks that need to be performed for one or more business processes, the staffing of employees or workers to complete those tasks, and the target time in which the one or more business processes should be completed.

Process View

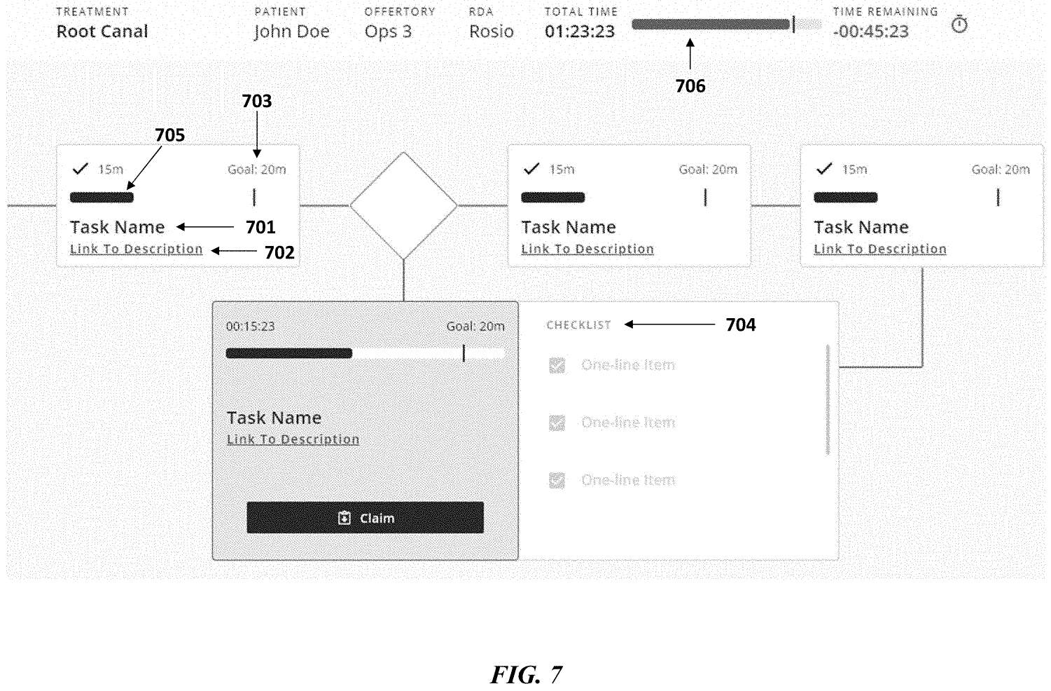

In some embodiments, the systems and methods of the present disclosure may be implemented by way of a user interface. The user interface may be configured to provide, for example, a process view that shows one or more tasks that need to be completed for a particular process. As shown in FIG. 7, the user interface may provide a user with a graphical overview of a process to be completed for a particular patient or operation. The user interface may also provide a graphical layout of each task to be completed for the process. Each task may have an associated task name 701 and task description 702, along with a goal time 703 in which to complete the task and a checklist 704 of items to confirm or address in order to complete the task. Each task may also have an associated progress bar 705 that tracks an amount of time that has elapsed since starting the task, or the amount of time taken to complete the task from start to finish. In some cases, the user interface may be configured to display an overall progress bar 706 for the entire process. The overall progress bar 706 may be used to track a total amount of time that has elapsed since the start of the process (e.g., when a user started the first task of the process).

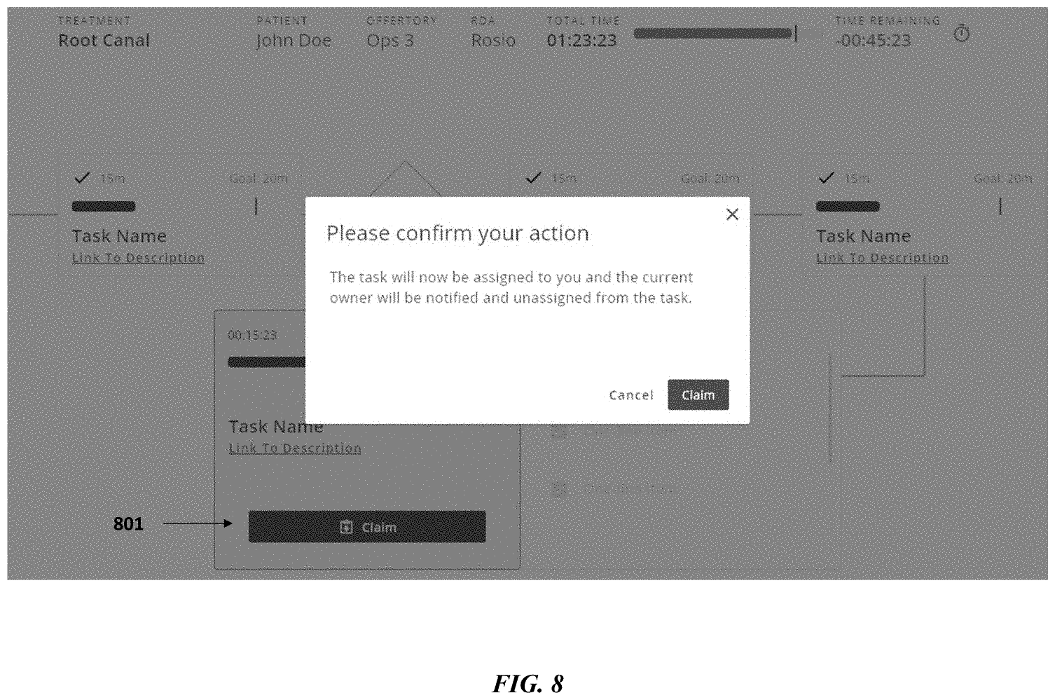

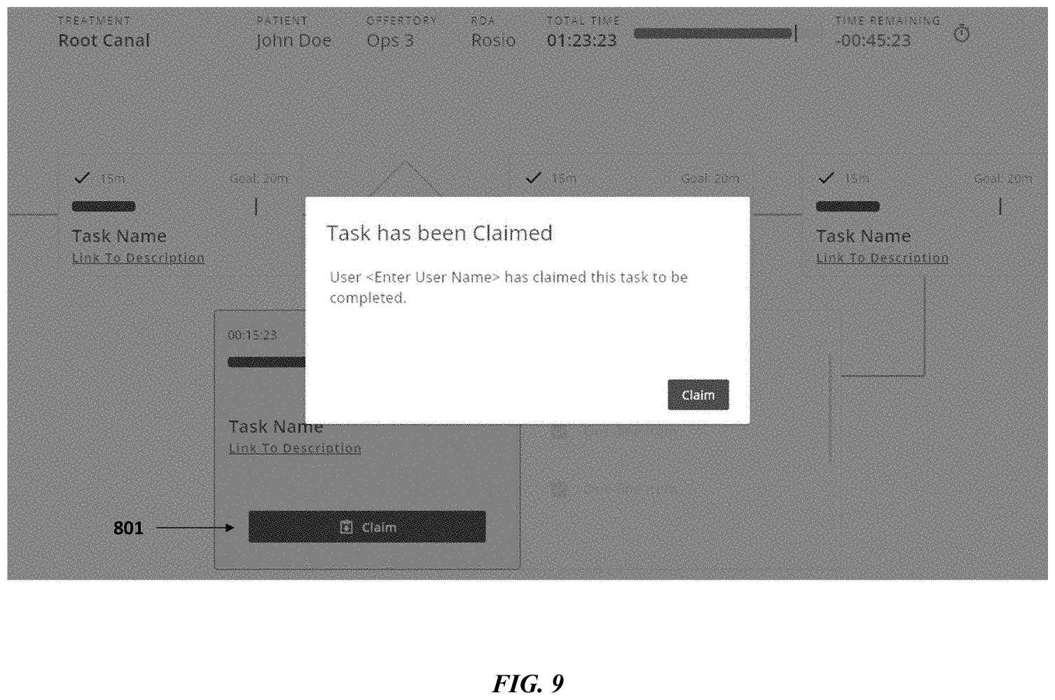

In some cases, the user interface may permit a user to claim a task. As illustrated in FIG. 8 and FIG. 9, a user may click a button 801 to claim a certain task. Upon clicking the button 801 to claim the task, the user interface may prompt the user to confirm their desired action to claim the task. Upon the user's confirmation, the user interface will notify the user and/or any other entities involved in managing or overseeing the process that the user has claimed the task.

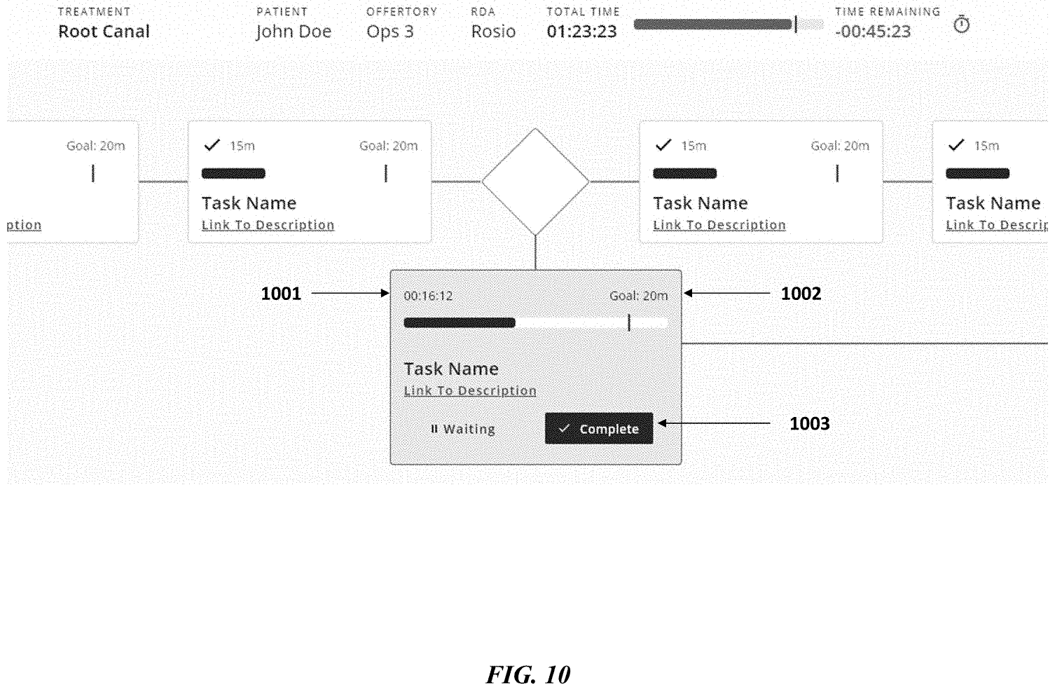

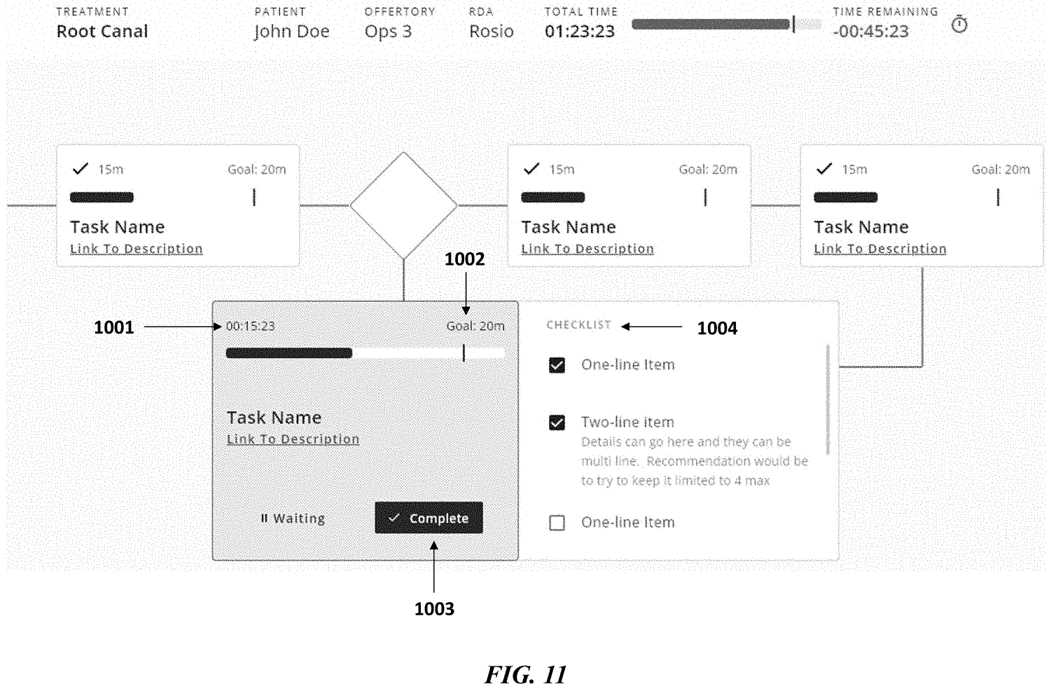

Referring to FIG. 10 and FIG. 11, once the user successfully claims the task, the user interface may be configured to start a timer 1001 that tracks the amount of time elapsed after the task has been claimed. The user interface may also indicate a goal time 1002 in which the user should complete the task. The goal time 1002 may be determined based on an optimized work flow map that is generated for the business or company at which the user is employed or working. Once the user completes the task, the user may press a button 1003 on the user interface to indicate that the task has been completed. Upon completion of the task, the system may log an amount of time actually taken to complete the task. In some cases, the user may only press the button 1003 to indicate task completion after the user has completed all items in the checklist 1004 associated with the claimed task.

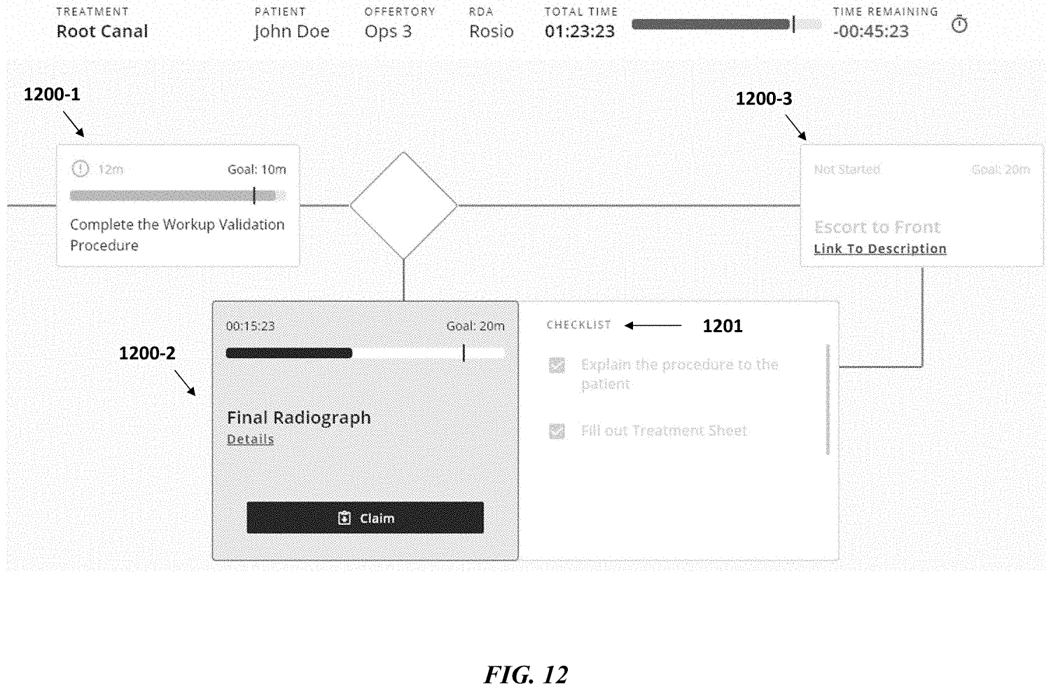

FIG. 12 shows an example of a process view for a root canal treatment. The process view may provide a user with a series of steps or tasks 1200-1, 1200-2, 1200-3 to complete for the treatment. For instance, after the user completes a first task 1200-1 (workup validation procedure), the user may claim a task 1200-2 to complete a final radiograph for the patient. After claiming the task 1200-2, the user may attend to the checklist 1201 of items associated with the final radiograph, which may include, for example, explaining the procedure to the patient and filling out a treatment sheet. Once the user completes the checklist 1201 of items and indicates that the task 1200-2 is completed, the process view may be updated to show a subsequent task 1200-3 (e.g., escorting the patient to the front of the office). The process view may be updated as tasks are completed by the user or other users also involved in cooperatively completing various tasks for the same procedure or operation. In some embodiments, the updated process view may be viewed by a manager or a business owner in real time for tracking or monitoring purposes.

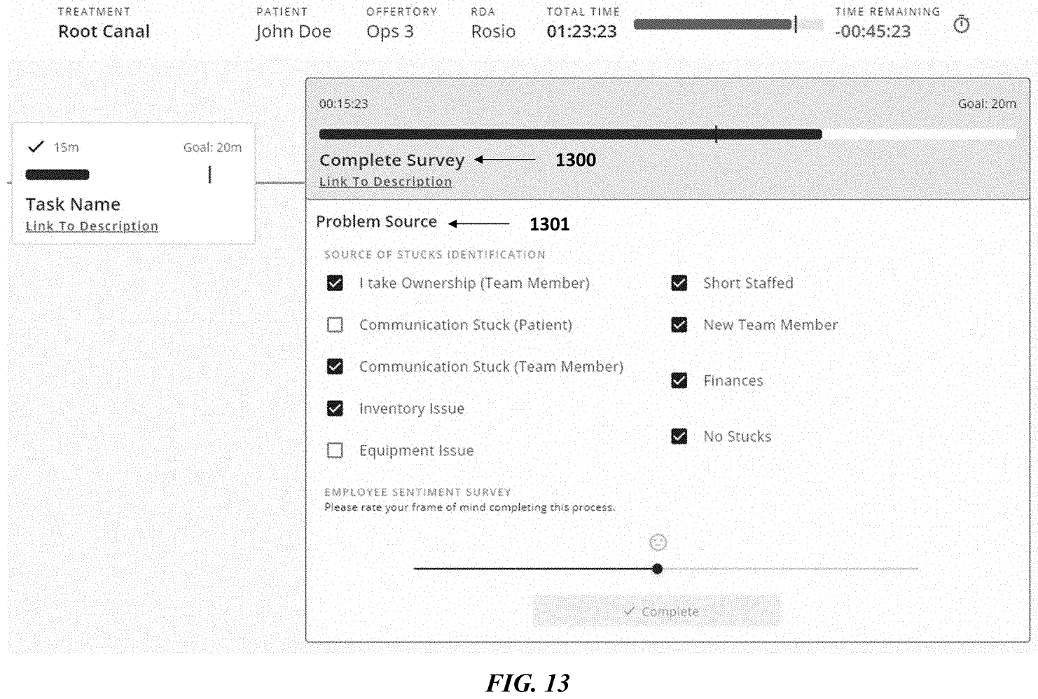

FIG. 13 schematically illustrates a survey 1300 that may be completed by one or more users involved in or supporting a process or any tasks associated with the process. The survey 1300 may permit a user to provide feedback on the work flow for the process, and to identify potential problem sources 1301 that may hinder the efficiency of the work flow. The potential problem sources 1301 may comprise, for example, communication issues between the user and patients or other team members, inventory issues, equipment issues, staffing issues, issues with working with new team members, finance issues, or any other issues that may impact the efficiency of the work flow. The user may also indicate that there were no issues. In some cases, the user may provide feedback on employee sentiment while performing various tasks of a procedure. In any of the embodiments described herein, feedback from the users may be used to further optimize or refine the business work flow, and/or to update the training programs for users. Such optimization and refinement may be performed on an ongoing basis as feedback is collected over multiple procedures.

Dashboard

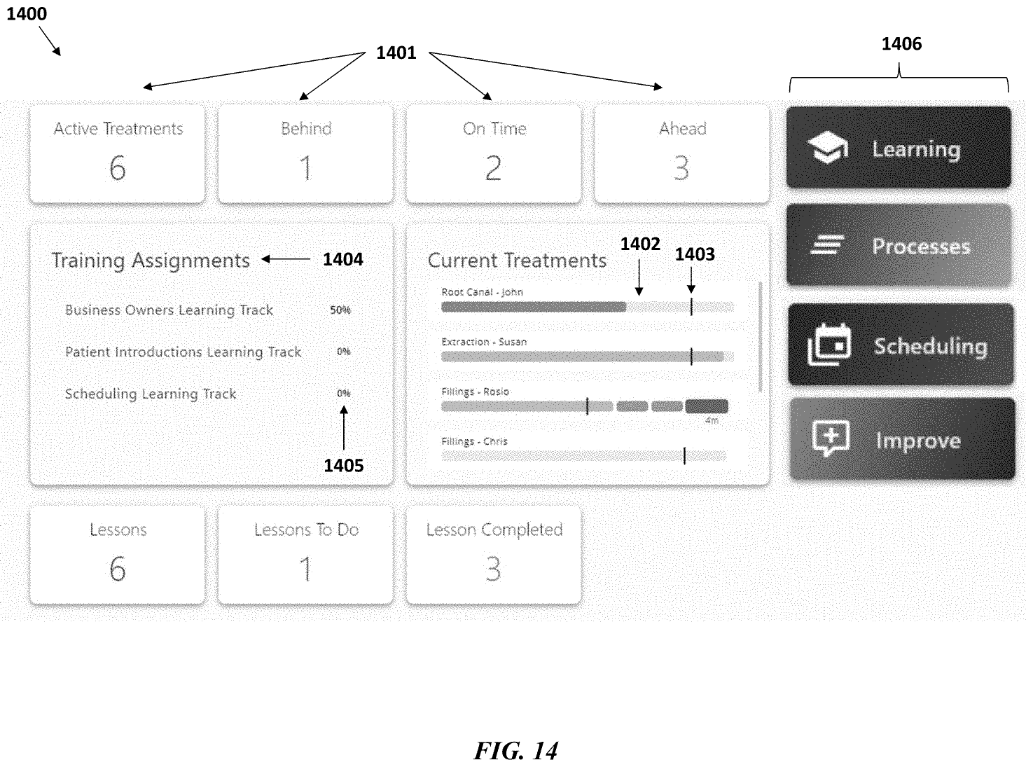

In some cases, the systems and methods of the present disclosure may be implemented by way of a dashboard. As shown in FIG. 14, the dashboard 1400 may present a user with information on one or more ongoing processes or procedures. The dashboard 1400 may provide status reports 1401 for active treatments, and lay out which treatments are on time, ahead of schedule, or behind schedule. The active treatments may be tracked along a virtual timeline 1402. The virtual timeline 1402 may indicate an optimal time limit 1403 in which to complete one or more treatments. Depending on the amount of time that has lapsed since beginning the one or more treatments, the virtual timeline 1402 may be configured to change a color of a progress bar associated with the virtual timeline 1402. The color of the progress bar may indicate whether the treatment or task/operation to be completed is on track, ahead of schedule, or behind schedule.

In some embodiments, the dashboard 1400 may present a list of training assignments 1404 to be completed, and a progress meter 1405 indicating (i) how much of each training assignment has been completed and/or (ii) how many training assignments have been completed. The progress meter 1405 may comprise, for example, a visual progress bar or a numerical display of (i) a number of training assignments completed or (ii) a percentage indicating how much of a training assignment has already been completed by a user. In some cases, the dashboard 1400 may provide a number of lessons available, a number of lessons to complete, and a number of lessons completed.

Cards

In some embodiments, the dashboard may provide one or more interactive buttons or cards 1406 (for example, as illustrated in FIG. 14). The interactive cards 1406 may be used to access, for example, a learning module for accessing lessons/training assignments and/or viewing reports or historical data, a processes module for viewing processes and/or claiming tasks, a scheduling module for scheduling tasks or assignments, and an ideation module for documenting and evaluating new ideas for improving workflows.

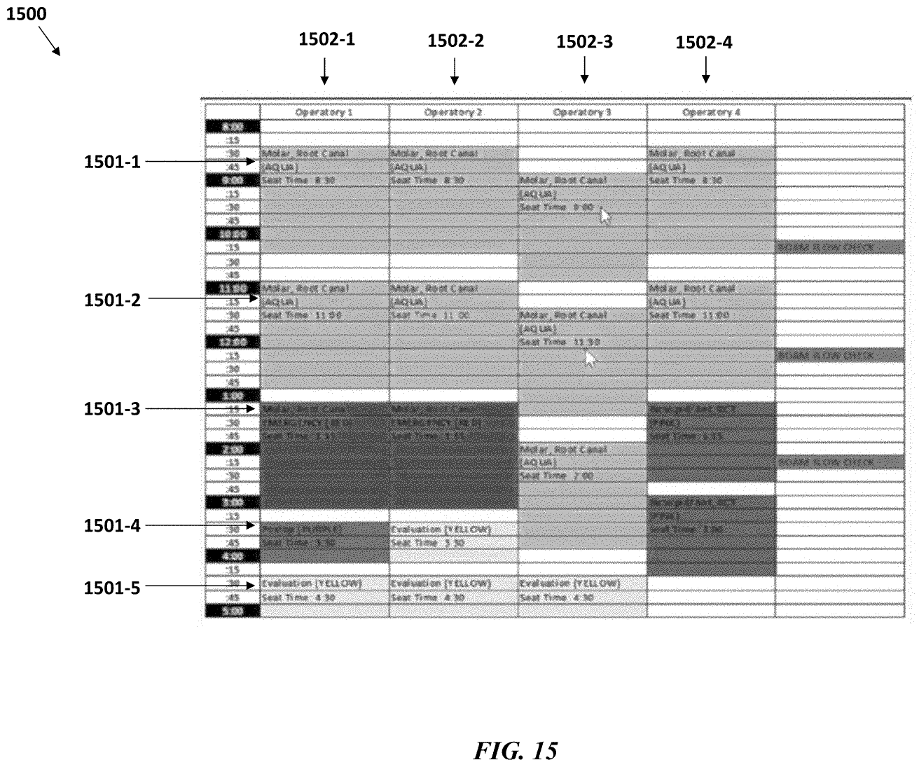

FIG. 15 shows an example of a schedule view 1500 that can provide a user with a high level overview of the scheduling of tasks 1501-1, 1501-2, 1501-3, 1501-4, 1501-5, etc. for each operation or process. In some cases, the tasks may be color coded by type or by urgency. The tasks may be grouped or arranged within a same row or column to indicate that the tasks are associated with a particular operatory 1502-1, 1502-2, 1502-3, 1502-4, etc. The scheduling of tasks for each operatory 1502-1, 1502-2, 1502-3, 1502-4 may be provided side by side and with respect to a common reference timeline to show a user which tasks are scheduled to occur during overlapping timeslots, for instance. In some cases, the scheduling of tasks may be automatically updated when an adjustment is made to a default target time for a process.

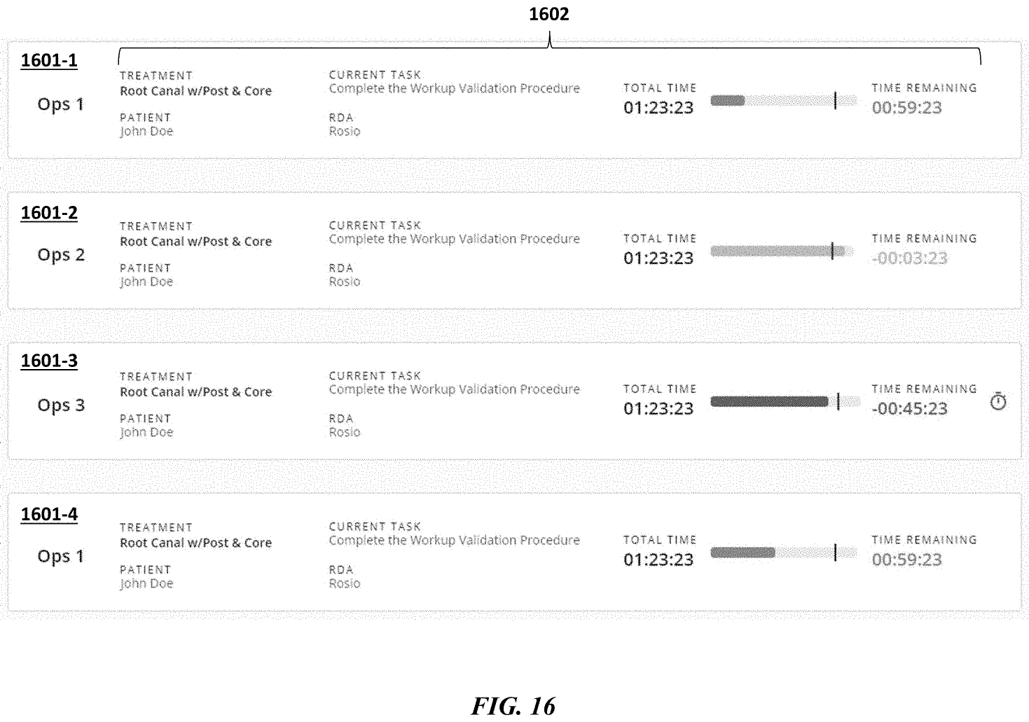

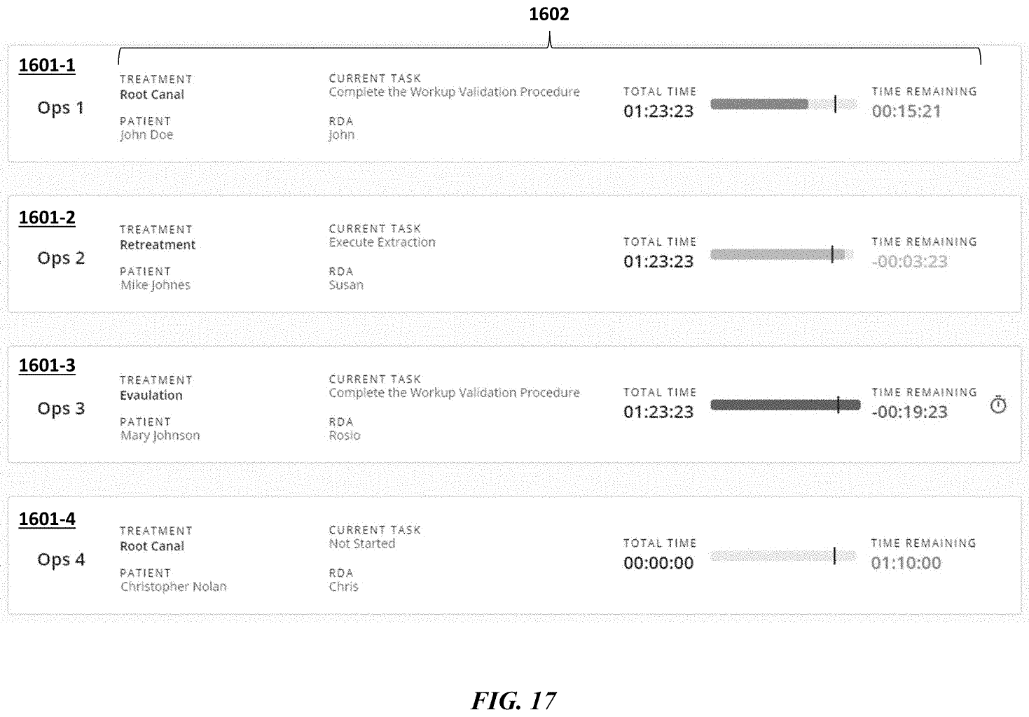

FIGS. 16 and 17 illustrate an overview of one or more operatories 1601-1, 1601-2, 1601-3, 1601-4. The overview may comprise a list of operatories 1601-1, 1601-2, 1601-3, 1601-4 that are currently in progress. Information 1602 about each operatory may be displayed for the user's reference. The information 1602 may comprise, for example, treatment type, patient name, current task, assigned operator, total time elapsed, and/or an amount of time remaining to complete the operatory within a target or goal time.

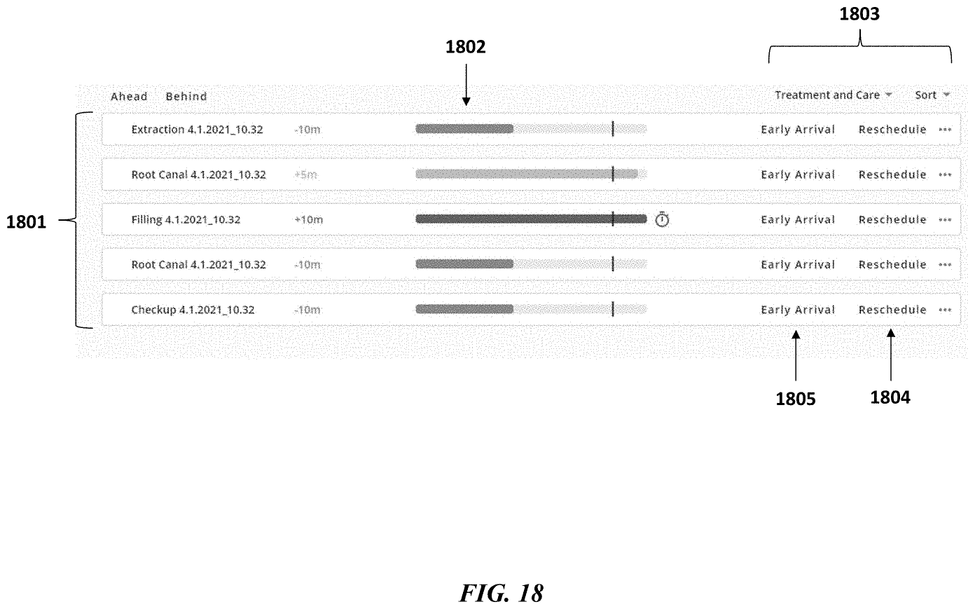

FIG. 18 illustrates an exemplary list of one or more process instances 1801 displayed within a user interface. The list of process instances 1801 may show a list of all processes that are running. A user may filter through the process instances 1801 for each type of process. Each type of process may have an associated list of process instances that are currently active, and a status bar 1802 indicating if a task is ahead of schedule, on time, or behind schedule, and the amount of time by which the task is ahead of or behind schedule. In some cases, the user interface may allow a user to filter and/or sort 1803 the processes to view only processes that are ahead of schedule, or behind schedule. In some cases, the user interface may provide an option to reschedule 1804 a process instance, or to indicate an early arrival 1805 for a patient associated with the process instance.

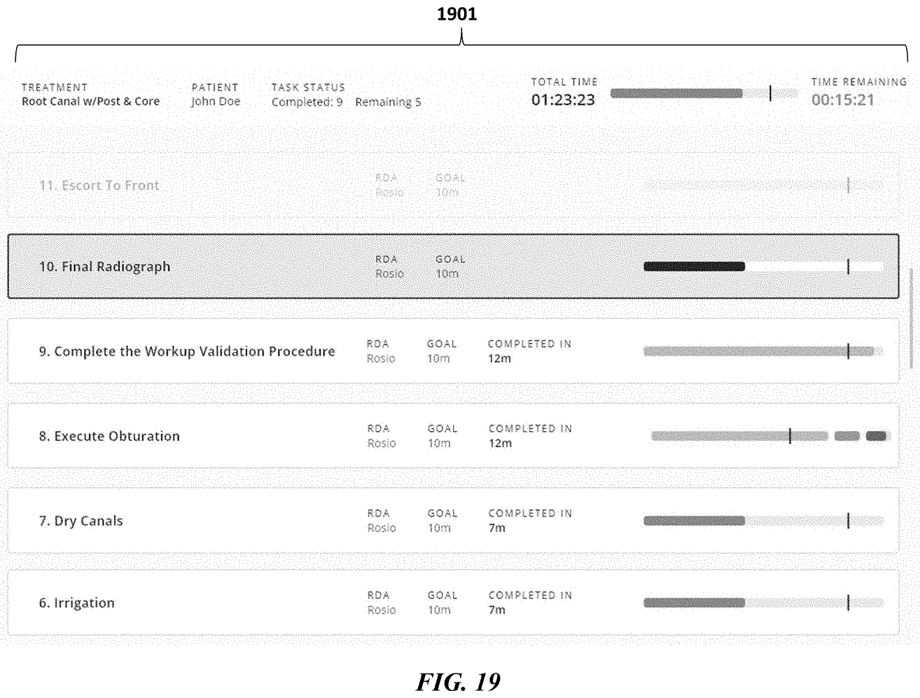

FIG. 19 illustrates a user interface configured to display process details 1901 for a process instance that is currently running. The process details 1901 may provide information on the type of treatment, the patient name, and the task status (e.g., number of tasks completed and number of tasks remaining). In some cases, the process details 1901 may provide information on a total time elapsed since the start of the task and the time remaining to complete the task within an optimal time period or goal time. As each task is being completed, the amount of time elapsed may be tracked, and the progress bar for the task may gradually fill. In some cases, the progress bar may change color to indicate whether the task is ahead of schedule or behind schedule. As tasks are completed, the user interface may be updated to show the amount of time taken to complete the process. In some cases, the process details 1901 for a process instance may include a chronological or reverse-chronological listing of tasks to be completed for the process. Each task associated with the process may have respective task information that is displayed to the user. The task information may include, for instance, the operator assigned to the task, the goal time, the amount of time taken to complete the task, and in some cases, a visual progress bar tracking (i) how much time has elapsed since the operator started the task against (ii) the goal time for completing the task.

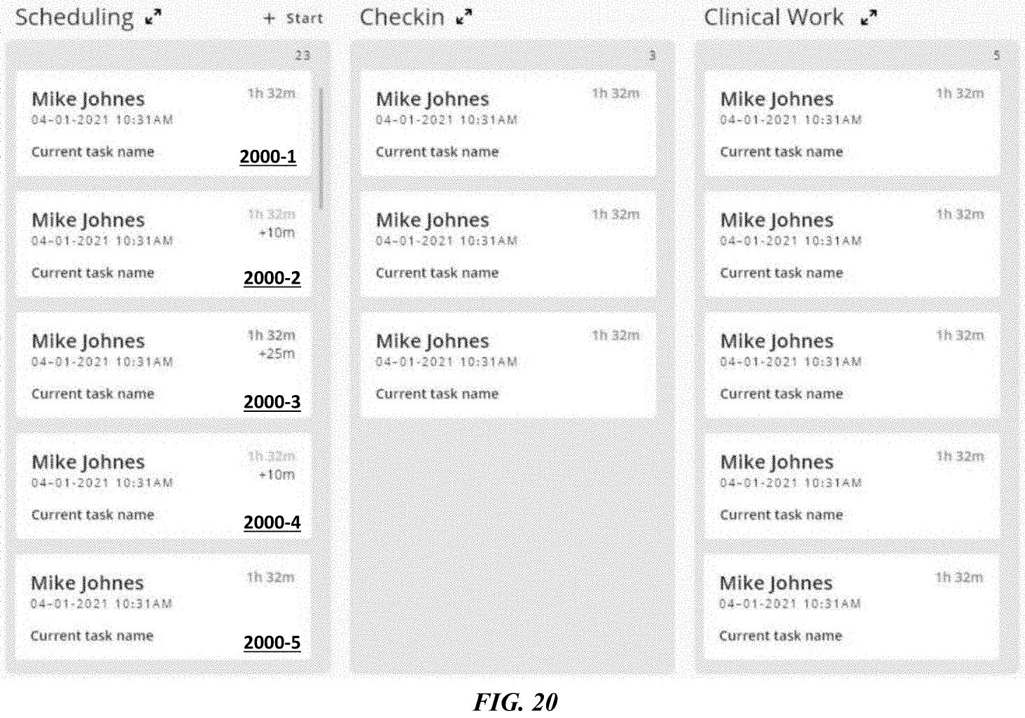

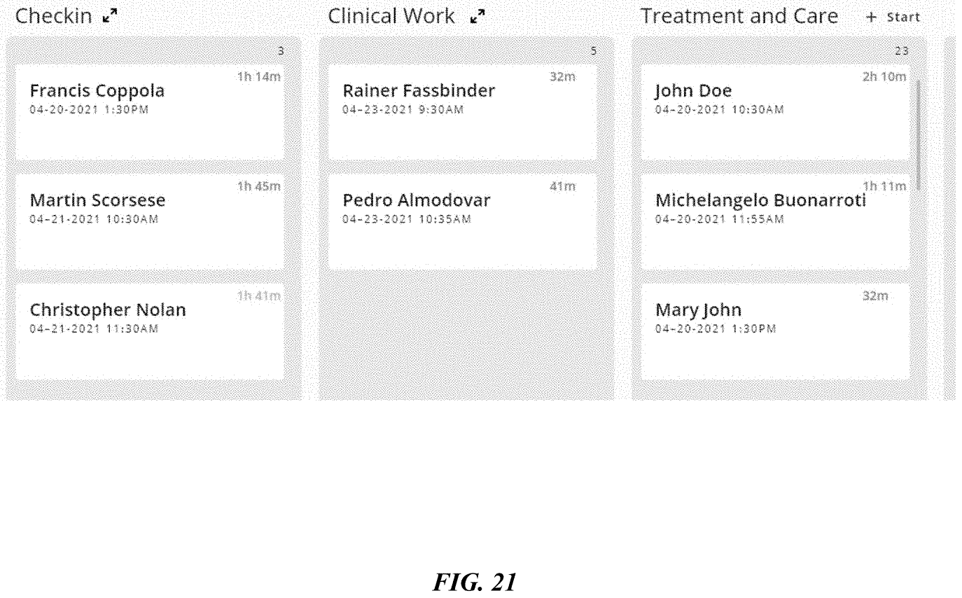

FIGS. 20 and 21 illustrate an exemplary list of processes 2000-1, 2000-2, 2000-3, 2000-4, 2000-5, etc. organized within a user interface. The list of processes 2000-1, 2000-2, 2000-3, 2000-4, 2000-5 may be categorized by type. The type of processes may be categorized, for example, as scheduling tasks, check in tasks, clinical work/evaluation, treatment and care, or checkout procedures. Each listed process 2000-1, 2000-2, 2000-3, 2000-4, 2000-5 may provide information such as patient name, task name, and the target (i.e., suggested or optimal) amount of time remaining to complete the process.

Reports

In some cases, the dashboard may be used to access or generate one or more reports. The reports may be generated from historical data associated with previously completed tasks or assignments (e.g., timing for each tasks, individuals who performed each task, efficiency of the workflow, etc.).

In some cases, the reports may be used to generate one or more insights that can help to inform various business decisions. For example, one or more metrics such as office capacity (i.e., total hours of work completed divided by total time of all individuals in the office or working remotely) or total dead time (i.e., difference between the time captured or billed in software and the scheduled hours for office employees) may help a business owner decide if they should grow or downsize their team.

In some cases, the reports may be used to view which processes, tasks, or operatory rooms are ahead or behind suggested times, and which are generally on schedule. The reports may also provide information on the number of cases completed over a certain time period and/or by location, as well as survey results of patients and employees by location and over time.

In some cases, the reports may provide information on efficiency of the workflow. For example, the reports may provide information on overall efficiency, employee sentiment, whether to grow or downsize, capacity/bandwidth, dead time, process times, number of cases completed, number of processes that are on time or late, patient sentiment, reliability score, number of phone calls made or received, strengths and/or weaknesses of the current business workflow, process performance vs training progress, or any other performance metrics relating to the business workflow.

In some cases, the reports may be used to present live data of procedures or processes that are happening in real time and inferences derivable from such live data. In other cases, the reports may be used to present historical data or any inferences derivable from such historical data.

Notifications

In some cases, the user interfaces disclosed and described herein may be configured to provide notifications to various users, employees, or business managers. The notifications may provide a reminder for a user to complete a task, an alert that a user has completed a task, or a notice that a process has exceeded a target or goal time. The notification may be provided on a panel or fly out window, or may be a pop up notification. The notification may be provided to the user while the user is viewing, for instance, a process view for a treatment.

Workflow Optimization

As described elsewhere herein, the systems and methods of the present disclosure may be implemented to optimize business workflows. In one aspect, the present disclosure provides a method for optimizing business workflows. The method may comprise: generating a workflow map based on one or more model business maps, which one or more model business maps may correspond to one or more processes or procedures of a model business; and optimizing the workflow map for a target business by adjusting the workflow map based on a business characteristic of the target business. The business characteristic may comprise, for example, a size of the target business, a client base of the target business, financial data of the target business, or one or more operational procedures of the target business. The target business may be different than the model business. In some embodiments, the method may comprise generating one or more training programs based on the optimized workflow map. In other embodiments, the method may comprise providing real-time guidance or task/procedure tracking to one or more agents performing various tasks or procedures for the target business.

In some embodiments, a feedback loop may be implemented to adjust the optimized workflow map or the one or more training programs. The feedback loop may be configured to adjust the optimized workflow map or the one or more training programs based on (i) feedback from one or more agents performing a task or procedure or (ii) one or more performance metrics of the target business. The one or more performance metrics may comprise (i) an efficiency of the target business or (ii) an amount of time in which the one or more agents complete the task or procedure. In some cases, the efficiency of the target business may correspond to a number of tasks or procedures completed per unit time, or other types of efficiency or performance metrics as described elsewhere herein.

In some cases, generating the workflow map may comprise (i) generating one or more tasks for completing a process or a procedure of the target business and (ii) assigning a target time limit to complete the one or more tasks. The one or more tasks may be automatically or manually assigned to one or more agents. In some cases, the one or more tasks may be assigned to the one or more agents using one or more algorithms. In some cases, the one or more tasks may be manually claimed by one or more agents, or by algorithmic suggestion.

In some embodiments, the one or more model business maps may comprise (i) a collection of one or more tasks for completing a process or procedure of the target business and/or (ii) operational data associated with the process or procedure. In some cases, the operational data may comprise timing information for completing the one or more tasks. In some cases, the operational data may comprise staffing information for assigning or delegating the one or more tasks to one or more agents. In some cases, the operational data may comprise an order in which the one or more tasks are completed or performed.

In some embodiments, optimizing the workflow map may comprise adjusting a timing for performing or completing one or more tasks associated with a procedure or a process of the target business. In other embodiments, optimizing the workflow map may comprise adjusting an order in which one or more tasks are performed. The one or more tasks may be associated with a procedure or a process of the target business.

In some cases, optimizing the workflow map may comprise adjusting staffing for one or more tasks associated with a procedure or a process of the target business. In other cases, optimizing the workflow map may comprise adjusting a scheduling of tasks associated with a procedure or a process of the target business.

In some embodiments, the method may further comprise using one or more algorithms to adjust the scheduling of tasks associated with the procedure or the process of the target business. In some cases, the scheduling of tasks may comprise dynamic task scheduling that is implemented via an algorithm, machine learning, artificial intelligence, or heuristics. Such dynamic task scheduling may permit real-time modifications or adjustments of customer appointment times to enhance service team and customer timing coordination and efficiency.

In some cases, optimizing the workflow map may comprise adjusting a scheduling of tasks associated with a procedure or a process of a target business. In some cases, one or more algorithms may be used to adjust the scheduling of tasks associated with the procedure or the process of the target business. In some cases, the scheduling of tasks may comprise dynamic task scheduling that is implemented via an algorithm (e.g., a multi-objective dynamic programming based algorithm or a restricted dynamic program heuristic algorithm), machine learning, artificial intelligence, and/or heuristics (e.g., insertion and local search heuristics). The dynamic task scheduling may permit real-time modifications or adjustments of customer appointment times to enhance service team and customer timing coordination and efficiency.

In some cases, the systems and methods of the present disclosure may be implemented to provide dynamic coupled multitask guidance (e.g., to optimize the scheduling of multiple tasks) based on the optimized workflow map. Such multitask guidance may help to enhance service team timing, coordination, and efficiency. In some cases, the multitask guidance may be provided by or generated using one or more algorithms (e.g., a dynamic programming algorithm or a heuristics algorithm), machine learning, artificial intelligence, and/or heuristics.

In some alternative non-limiting embodiments, the methods of the present disclosure may comprise providing dynamic coupled multitask guidance based on the optimized workflow map to enhance service team timing, coordination, and efficiency. The multitask guidance may be provided by or generated using one or more algorithms, machine learning, artificial intelligence, or heuristics.

Computer Systems

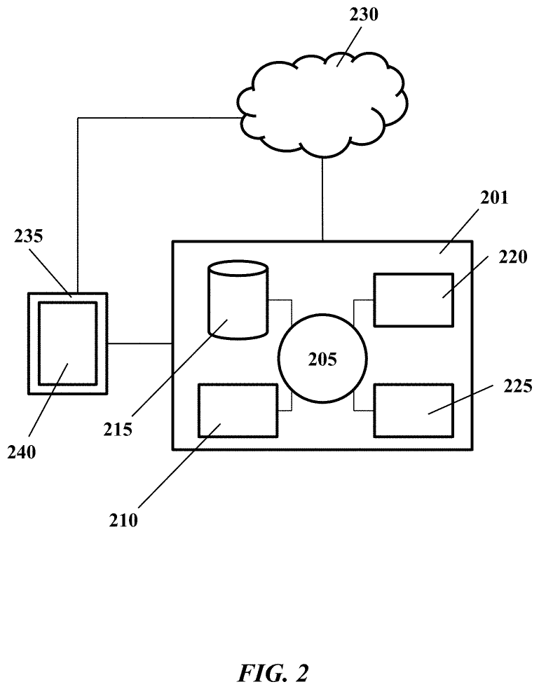

In an aspect, the present disclosure provides computer systems that are programmed or otherwise configured to implement methods of the disclosure, e.g., any of the subject methods for optimizing business workflows. FIG. 2 shows a computer system 201 that is programmed or otherwise configured to implement a method for optimizing business workflows. The computer system 201 may be configured to, for example, obtain business maps of model companies and generate one or more business workflows based on the business maps. The one or more business workflows may be customized or optimized for other businesses in a same or different industry. In some cases, the computer system may be further configured to create training programs to teach employees how to operate in accordance with an optimized business work flow. In some cases, the computer system may be further configured to implement a feedback loop with data analytics to further optimize the work flow processes and/or the training programs. The computer system 201 can be an electronic device of a user or a computer system that is remotely located with respect to the electronic device. The electronic device can be a mobile electronic device.

The computer system 201 may include a central processing unit (CPU, also “processor” and “computer processor” herein) 205, which can be a single core or multi core processor, or a plurality of processors for parallel processing. The computer system 201 also includes memory or memory location 210 (e.g., random-access memory, read-only memory, flash memory), electronic storage unit 215 (e.g., hard disk), communication interface 220 (e.g., network adapter) for communicating with one or more other systems, and peripheral devices 225, such as cache, other memory, data storage and/or electronic display adapters. The memory 210, storage unit 215, interface 220 and peripheral devices 225 are in communication with the CPU 205 through a communication bus (solid lines), such as a motherboard. The storage unit 215 can be a data storage unit (or data repository) for storing data. The computer system 201 can be operatively coupled to a computer network (“network”) 230 with the aid of the communication interface 220. The network 230 can be the Internet, an internet and/or extranet, or an intranet and/or extranet that is in communication with the Internet. The network 230 in some cases is a telecommunication and/or data network. The network 230 can include one or more computer servers, which can enable distributed computing, such as cloud computing. The network 230, in some cases with the aid of the computer system 201, can implement a peer-to-peer network, which may enable devices coupled to the computer system 201 to behave as a client or a server.

The CPU 205 can execute a sequence of machine-readable instructions, which can be embodied in a program or software. The instructions may be stored in a memory location, such as the memory 210. The instructions can be directed to the CPU 205, which can subsequently program or otherwise configure the CPU 205 to implement methods of the present disclosure. Examples of operations performed by the CPU 205 can include fetch, decode, execute, and writeback.

The CPU 205 can be part of a circuit, such as an integrated circuit. One or more other components of the system 201 can be included in the circuit. In some cases, the circuit is an application specific integrated circuit (ASIC).

The storage unit 215 can store files, such as drivers, libraries and saved programs. The storage unit 215 can store user data, e.g., user preferences and user programs. The computer system 201 in some cases can include one or more additional data storage units that are located external to the computer system 201 (e.g., on a remote server that is in communication with the computer system 201 through an intranet or the Internet).

The computer system 201 can communicate with one or more remote computer systems through the network 230. For instance, the computer system 201 can communicate with a remote computer system of a user (e.g., an employee of a business, a business owner, a business manager, etc.). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 201 via the network 230.

Methods as described herein can be implemented by way of machine (e.g., computer processor) executable code stored on an electronic storage location of the computer system 201, such as, for example, on the memory 210 or electronic storage unit 215. The machine executable or machine readable code can be provided in the form of software. During use, the code can be executed by the processor 205. In some cases, the code can be retrieved from the storage unit 215 and stored on the memory 210 for ready access by the processor 205. In some situations, the electronic storage unit 215 can be precluded, and machine-executable instructions are stored on memory 210.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 201, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media including, for example, optical or magnetic disks, or any storage devices in any computer(s) or the like, may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 201 can include or be in communication with an electronic display 235 that comprises a user interface (UI) 240 for providing, for example, a portal for a business owner, a business manager, or an employee of a business to view a business workflow or a training program associated with the business workflow. The portal may be provided through an application programming interface (API). A user or entity can also interact with various elements in the portal via the UI. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 205. The algorithm may be configured to generate one or more optimized business workflows based on one or more model business maps. The algorithm may be further configured to create training programs to teach employees how to operate in accordance with an optimized business work flow. In some cases, the algorithm may be further configured to implement a feedback loop with data analytics to further optimize the work flow processes and/or the training programs.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method for optimizing business workflows, comprising:
(a) generating a workflow map based on one or more model business maps, wherein the one or more model business maps correspond to one or more processes or procedures of a model business;
(b) optimizing the workflow map for a target business by adjusting the workflow map based on a business characteristic of the target business, wherein the target business is different than the model business; and
(c) generating one or more training programs based on the optimized workflow map.

2. The method of claim 1, wherein the business characteristic comprises a size of the target business, a client base of the target business, financial data of the target business, or one or more operational procedures of the target business.

3. The method of claim 1, further comprising implementing a feedback loop to adjust the optimized workflow map or the one or more training programs.

4. The method of claim 3, wherein the feedback loop is configured to adjust the optimized workflow map or the one or more training programs based on (i) feedback from one or more agents performing a task or procedure or (ii) one or more performance metrics of the target business.

5. The method of claim 4, wherein the one or more performance metrics comprise (i) an efficiency of the target business or (ii) an amount of time in which the one or more agents complete the task or procedure.

6. The method of claim 5, wherein the efficiency of the target business corresponds to a number of tasks or procedures completed per unit time.

7. The method of claim 1, wherein generating the workflow map comprises (i) generating one or more tasks for completing a process or a procedure of the target business and (ii) assigning a target time limit to complete the one or more tasks.

8. The method of claim 7, wherein the one or more tasks are automatically or manually assigned to one or more agents.

9. The method of claim 8, wherein the one or more tasks are assigned to the one or more agents using one or more algorithms.

10. The method of claim 7, wherein the one or more tasks are manually claimed by one or more agents or by algorithmic suggestion.

11. The method of claim 1, wherein the one or more model business maps comprise (i) a collection of one or more tasks for completing a process or procedure of the target business and (ii) operational data associated with the process or procedure.

12. The method of claim 11, wherein the operational data comprises timing information for completing the one or more tasks.

13. The method of claim 11, wherein the operational data comprises staffing information for assigning or delegating the one or more tasks to one or more agents.

14. The method of claim 11, wherein the operational data comprises an order in which the one or more tasks are completed or performed.

15. The method of claim 1, wherein optimizing the workflow map comprises algorithmically adjusting a timing for performing or completing one or more tasks associated with a procedure or a process of the target business.

16. The method of claim 1, wherein optimizing the workflow map comprises adjusting an order in which one or more tasks are performed, wherein the one or more tasks are associated with a procedure or a process of the target business.

17. The method of claim 1, wherein optimizing the workflow map comprises adjusting staffing for one or more tasks associated with a procedure or a process of the target business.

18. The method of claim 1, wherein optimizing the workflow map comprises adjusting a scheduling of tasks associated with a procedure or a process of the target business.

19. The method of claim 18, further comprising using one or more algorithms to adjust the scheduling of tasks associated with the procedure or the process of the target business.

20. The method of claim 18, wherein the scheduling of tasks comprises dynamic task scheduling that is implemented via an algorithm, machine learning, artificial intelligence, or heuristics, wherein said dynamic task scheduling permits real-time modifications or adjustments of customer appointment times to enhance service team and customer timing coordination and efficiency.

21. The method of claim 1, wherein the one or more training programs comprise tools, lessons, or reference materials on how to complete or perform one or more tasks associated with a procedure or a process of the target business.

22. The method of claim 1, wherein the one or more training programs are assignable to one or more agents of the target business, wherein the one or more agents comprise an employee, an independent contractor, a worker, a manager, or a business owner of the target business.

23. The method of claim 1, wherein the one or more training programs are provided or accessible via wearable hardware.

24. The method of claim 23, wherein the wearable hardware comprises a watch, augmented reality (AR) or virtual reality (VR) glasses, AR or VR goggles, or an AR or VR headset.

25. The method of claim 1, further comprising providing dynamic coupled multitask guidance based on the optimized workflow map to enhance service team timing, coordination, and efficiency.

26. The method of claim 25, wherein the multitask guidance is provided by or generated using one or more algorithms, machine learning, artificial intelligence, or heuristics.
